(19) United States
(12) Patent Application Publication
(10) Pub. No.: US 2009/0143964 A1
(43) Pub. Date: Jun. 4, 2009

(54) VEHICLE DYNAMIC NAVIGATION SYSTEM AND METHOD

(75) Inventors: Piergiorgio Navone, Orbassano (IT); Mario Gambera, Orbassano (IT)

Correspondence Address: KLARQUIST SPARKMAN, LLP, 121 SW SALMON STREET, SUITE 1600, PORTLAND, OR, 97204, US

(73) Assignee: C.R.F. Societa Consortile per Azioni

(21) Appl. No.: 12/253,084

(22) Filed: Oct. 16, 2008

(30) Foreign Application Priority Data
Oct. 19, 2007 (EP) 07425661.1

(51) Int. Cl. G01C 21/36

(52) U.S. Cl. 701/117

(57) ABSTRACT

A vehicle navigation system is described, comprising an onboard navigation unit installed on board a vehicle that can be used by a user to set target destinations and an operations centre communicating with the onboard navigation unit. The onboard navigation unit is configured to transmit a target destination and a static road route to the operations centre. The operations centre is configured to calculate a dynamic road route based on the target destination, the static road route and information regarding the traffic conditions and road conditions of said road network and/or the static road route. In addition, the operations centre compares the calculated dynamic road route with the static road route and transmits information associated with a road route that is selected on the basis of the comparison to the onboard navigation unit.

### CROSS REFERENCE TO RELATED APPLICATIONS

This application claims priority to European Patent Application No. 07425661.1, filed on Oct. 19, 2007, which is hereby incorporated by reference in its entirety.

### BACKGROUND

As is known, the main function of vehicle navigation systems is to provide the driver of the vehicle with a sequence of graphical and/or vocal information regarding a route to follow to reach a desired and selectable destination in an optimal manner.

These systems are essentially composed of a receiver unit for radio signals originating from satellites forming part of a satellite positioning system, such as the GPS system for example, or from broadcast devices located in the area around the vehicle, a processing unit, which calculates the position of the vehicle based on the signal received from the satellite system, and a user interface that has the main task of providing the driver of the vehicle with graphical and/or vocal route information. The user interface is used in the navigation system for entering the necessary data for calculating the route.

Among the known navigation systems offered by the major vehicle manufacturers, there are navigation systems of the onboard type, in which calculation of the route requested by the user is carried out directly onboard the vehicle by a specially provided processing unit, and navigation systems of the off-board type, in which calculation of the route requested by the user is carried out externally to the vehicle.

In particular, in the off-board navigation systems, calculation of the route between the current position of the vehicle and the destination that the user wishes to reach is carried out by an operations centre in communication with the vehicle and transmitted by the centre to the navigation system integrated on board the vehicle, which receives the calculated data from the operations centre and provides the driver with the graphical and/or vocal instructions on the route to follow.

The main advantage of off-board navigation systems is that of achieving a fundamental simplification of the navigation system integrated on board the vehicle, as the processing unit of the onboard navigation system limits itself to calculating the position of the vehicle, but does not implement the algorithms necessary to calculate routes, nor does it need all of the data storage units necessary for storing cartographic maps.

Another advantage of off-board navigation systems consists in that the updating of information of a geographic nature used for calculating the routes requested by the user is carried out with an opportune frequency directly by the operations centre, relieving the user of this task. This guarantees the supply of an ever-efficient service, the reliability of which is not affected by possible errors due to geographic information that has not been updated by the user.

At present, vehicle navigation systems constitute a commercial product in strong expansion, due both to the need of car manufacturers to differentiate themselves in vehicle ranges equipped with technological systems increasingly on the cutting-edge, and because of the new road mobility needs of motorists who drive in increasingly complex scenarios and need and an ever-increasing amount of varied information. This has caused the development of “dynamic” navigation systems, of both off-board and onboard types, which do not limit themselves to providing the driver of the vehicle with a series of instructions on how to reach a predetermined destination, but which are also capable of providing the user with additional information, such as traffic information for example. Dynamic navigation systems are also able to monitor the route driven along by the user in relation to the road conditions and to provide the user with an alternative route in cases where events arise that compromise the road conditions of the route being taken, such as accidents or heavy traffic for example.

However, both the off-board and onboard types of dynamic navigation systems have drawbacks.

For example, off-board dynamic navigation systems oblige the user to delay commencing navigation and to wait until information regarding the requested route is received from the operations centre.

Instead, the main drawback of onboard dynamic navigation systems is mainly caused by the large amount of data concerning the road conditions of the road network, which must be periodically provided to the onboard system and which the latter must process. In fact, first of all, the transmission of such a large amount of data requires the constant availability of rather high bandwidth, while its processing by the onboard system requires the use of high-performance processing and data storage units, which are generally rather expensive and thus condition the overall cost of the vehicle.

### SUMMARY

The object of the present invention is to provide a dynamic navigation system and method that overcomes at least part of the drawbacks of known dynamic navigation systems.

According to the present invention, a dynamic navigation system is provided, as defined in the attached claims.

### BRIEF DESCRIPTION OF THE DRAWINGS

For a better understanding of the present invention, a preferred embodiment shall now be described, purely by way of a non-limitative example, with reference to the enclosed drawings, where:

FIG. 1 shows a dynamic navigation system forming the subject of the present invention, and

FIG. 2 shows a flowchart of the method of navigation implemented by the dynamic navigation system of the present invention.

### DETAILED DESCRIPTION

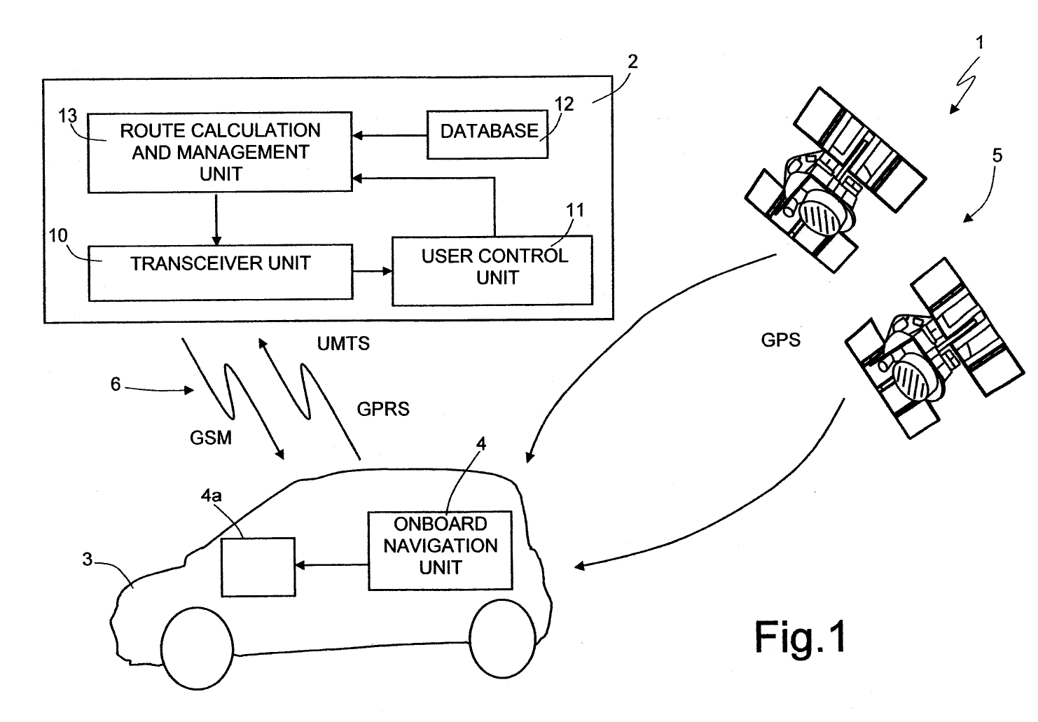

As shown in FIG. 1, the navigation system 1 comprises at least one operations centre 2, an onboard navigation unit 4 installed on board a vehicle 3, a satellite positioning system of known type 5, such as GPS for example, cooperating with the onboard navigation unit 4 and a mobile two-way communications network of known type 6, for example GSM, GPRS or UMTS, inserted between the operations centre 2 and the vehicle 3.

The vehicle 3 in FIG. 1 is also equipped with sensors of known type (not shown in the figure) connected to the onboard navigation unit 4 and providing output signals indicating the speed and direction of travel of the vehicle 3, for example, an odometer and a gyroscope. Optionally, the vehicle 3 in FIG. 1 could also be equipped with a computerized system of known type (not shown in the figure) for detecting vehicle traffic, of the Floating Car Data type for example, henceforth indicated by the initials FCD.

The FCD computerized system is able to recognise, in a completely automatic manner, the state of road traffic congestion due to the circulation of road vehicles, motor vehicles in particular, and allows transmission of the vehicle's position to a remote station.

In particular, always with reference to FIG. 1, the onboard navigation unit 4 is equipped with:

a data storage unit (not shown in FIG. 1) on which cartographic information regarding a plurality of routes present within the territory is stored,

means (not shown in the figure) for receiving radio signals transmitted by the GPS satellite positioning system 5 and signals originating from the odometer and the gyroscope,

means (not shown in the figure) for transmission and reception of radio signals that allow two-way data exchange with the operations centre 2 via the mobile communications network 6, and

a processing unit (not shown in FIG. 1) configured to calculate the current position of the vehicle and to implement the necessary algorithms for calculating the routes requested by the user.

In particular, the processing unit is configured to determine the current position of the vehicle based on signals coming from the GPS satellite positioning system 5 and to calculate the position of the vehicle, even in cases where the vehicle is in areas not reached by the signals coming from the GPS satellite system. To this end, the onboard navigation unit 4 is configured to implement a known algorithm of the DEAD RECKONING type, which calculates the position of the vehicle 3 on the basis of the speed and direction of travel of the vehicle 3, supplied to the onboard navigation unit 4 by the signals coming from the odometer and the gyroscope, and the last position calculated on the basis of the signals coming from the GPS satellite system.

In particular, the onboard navigation unit 4 comprises at least one user interface 4a (shown schematically), which can be equipped with its own display or use the display of the instrument panel and which allows the user to carry out all of the operations necessary for using the dynamic navigation system 1.

For example, the user can enter the data of a target destination or enter commands (full details given further on) for communication with the operations centre 2. This data and these commands are given according to the normal methods provided in this sector, for example, by using a graphical interface and pull-down menus displayed on the display unit 4b.

Always with reference to FIG. 1, the operations centre 2 comprises:

means of transmission and reception 10 for two-way data transmission between the operations centre 2 and the onboard navigation unit 4,

a user control unit 11 in which at least one database is stored containing identity information and the type of service subscribed to by the users of the navigation system 1 and configured to manage the user information,

a database 12 containing information regarding the traffic conditions and road conditions of the road network in a portion of territory, for example, in relation to freedom of access to road routes, weather conditions, roadworks, etc., and

a route processing and management unit 13 in which at least one database is stored containing information of a cartographic nature regarding a plurality of roads present within the territory, and which has the task of calculating dynamic road routes based on information coming from the navigation unit 4 of the vehicle 3 and information regarding traffic conditions and road conditions coming from the monitoring system 12.

In particular, the operations centre is configured to receive information regarding traffic conditions and road conditions of the road network from a remote monitoring station (not shown in the figure) and to update the database 12 on the basis of this information.

In particular, the user control unit 11 cooperates with the means of transmission and reception 10 and with the route processing and management unit 13, and is configured to receive information via the means of transmission and reception 10 regarding the identification of the onboard navigation unit 4, on the basis of which the user control unit 11 identifies the vehicle 3 and the type of service subscribed to by the user driving the vehicle 3.

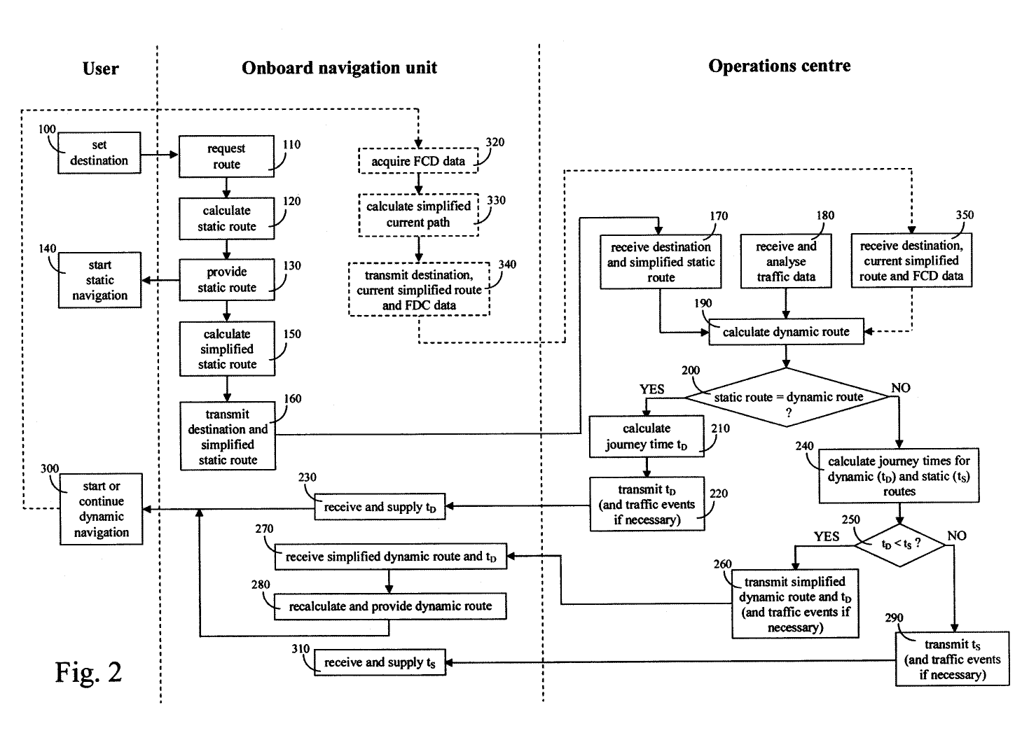

FIG. 2 shows a flowchart of the phases of the navigation method implemented by the dynamic navigation system of the present invention.

In particular, as shown in FIG. 2, when a user needs information regarding a new route, he/she sets the target destination via the user interface 4a and the request is sent to the onboard navigation unit 4 (block 100) that, upon receiving the aforementioned request (block 110), calculates a static route, or rather one based just on information of a geographic nature and possible weights that take into account the driving characteristics of stretches of roads, but without taking into account the effects of traffic that influence the road conditions of the route (block 120), which allows the user to reach the set target destination. In particular, the static route is calculated on the basis of the current position of the vehicle, the destination set by the user and information of a cartographic nature stored in the onboard navigation unit 4.

Consequently, the onboard navigation unit 4 provides the user with the calculated static route (block 130) via the user interface 4a, who can then commence static navigation (block 140) on the basis of the supplied information.

After having calculated the static route, in block 150, the onboard navigation unit 4 calculates a simplified version of the static route provided to the to the user, for example, by means of the Douglas-Peucker algorithm with which a simplification of a polyline can be determined, or through determining a plurality of identifiers for crossroads and/or more important stretches of the route, or simply by determining a plurality of points distributed along the route.

Then, in block 160, through the specially provided means of radio signal transmission and reception, the onboard navigation unit 4 transmits the following to the operations centre 2: identity information and the type of service subscribed to by the user of the vehicle 3, information regarding the destination set by the user and that regarding the simplified route.

When the operations centre 2 receives the data sent by the user (block 170) via the transceiver unit 10, first of all it checks, via the user control unit 11, if the user is enabled to receive the services offered by the operations centre 2.

If so, the route processing and management unit 13 of the operations centre 2 calculates the best possible dynamic route (block 190), that is on the basis of information regarding the traffic conditions and the road conditions of the individual stretches of the road network provided in block 180 by the monitoring system 12, which monitors and analyzes traffic flow in order to determine events that affect the state of driving conditions of each stretch of road.

After having calculated the dynamic route, in block 200 the route processing and management unit 13 compares the simplified static route sent by the onboard navigation unit 4 with the calculated dynamic route and, in cases where the static route is substantially equal to the dynamic route, the YES exit in block 200 is taken and, in block 210, the route processing and management unit 13 calculates a journey time t_{D} for the dynamic route. The journey time t_{D} of the dynamic route is then transmitted (block 220) from the operations centre 2, through the transceiver unit 10, to the onboard navigation unit 4 that, after receiving it, provides it to the user via the interface 4a, (block 230).

In addition to the journey time t_{D} of the dynamic route, the operations centre 2 could also be configured to transmit information to the onboard navigation unit 4 regarding events that could influence the road conditions of the calculated dynamic route, this information arriving from the remote monitoring station and then stored in the database 12.

In the case where the dynamic route is significantly different from the static route, the NO exit in block 200 is taken, the route processing and management unit 13 calculates the journey time t_{D} for the calculated dynamic route (block 240) and a journey time t_{S} for the simplified static route sent by the onboard navigation unit 4 and, in block 250, compares journey time t_{D} with journey time t_{S}.

In the case where the journey time t_{D} of the dynamic route is less than or equal to the journey time of the static route t_{S}, the YES exit in block 250 is taken and the operations centre 2 transmits a simplified version of the calculated dynamic route and the associated journey time t_{D} to the onboard navigation unit 4. In this case as well, the operations centre 2 could also be configured to transmit information to the onboard navigation unit 4 regarding events that could influence the road conditions of the calculated dynamic route, this information arriving from the remote monitoring station and then stored in the database 12, block 260.

The information regarding the simplified dynamic route and the associated journey time t_{D} and, if present, that regarding the aforementioned events, is then received by the onboard navigation unit 4, block 270.

The onboard navigation unit 4 then calculates a new route based on the simplified dynamic route received, which is as similar as possible to the simplified dynamic route received, and provides the calculated route to the user, block 280.

In the case where the journey time t_{D} of the dynamic route is greater than the journey time of the static route t_{S}, the NO exit in block 250 is taken and the operations centre 2 transmits just the journey time t_{S} of the static route and, if present, information regarding any detected events that might influence the road conditions of the calculated dynamic route, to the onboard navigation unit 4, block 290.

The information regarding the journey time t_{S} of the route, and possibly that regarding the aforementioned events, is then received by the onboard navigation unit 4 and provided to the user by the latter, block 310.

The above-described route determination and dynamising procedure allows the user to continue navigation in a “dynamic” manner, that is by taking into account the traffic conditions and road conditions of the route, independently of whether or not the operations centre determines an alternative route to that calculated by the onboard navigation unit 4, and the result of the comparison between the associated journey times t_{D} and t_{S}.

Optionally, once the above-described route determination and dynamising procedure has terminated, the dynamic navigation system 1 could be configured to implement a procedure for monitoring and, if necessary, updating the route followed by the vehicle 3.

This route monitoring and updating procedure is shown in FIG. 2 by means of the blocks depicted with a dashed line.

In particular, to that end, the vehicle acquires data regarding vehicle traffic (block 320), which is continuously detected by the FCD computerized system from the moment in which navigation is commenced, and the current position of the vehicle, calculates a simplified version of the currently followed route (block 330) as described in reference to block 150, and transmits the current position of the vehicle, the destination set by the user, the data regarding vehicle traffic and the simplified version of the currently followed route (block 340) to the operations centre 2 via the specially provided means of radio signal transmission and reception.

The aforementioned information is received by the operations centre 2 via the transceiver unit 10 (block 350) and, based on the aforementioned information, the operations centre 2 repeats the procedure described in blocks 190 to 310.

The above-described monitoring and updating procedure for the route followed by the vehicle 3 is implemented by the dynamic navigation system 1 in a continuous manner throughout navigation. In this way, it is possible to provide the user with a continuously up-to-date route, in function of the actual traffic conditions and road conditions or, if necessary, an alternative route to the route currently being followed in order to allow the user to dynamically navigate to the target destination.

The advantages of the above-described system and method of dynamic onboard navigation are evident.

The implementation of the route determination and dynamising procedure shown in FIG. 2 allows the user to commence navigating almost immediately, without having to wait to receive information from the operations centre. In fact, the calculation of the static route carried out via the onboard navigation unit 4 allows the user to be provided with information on the route to follow in a short space of time, which depends exclusively on the processing speed of the onboard navigation unit 4, but does not need external information.

Furthermore, carrying out the dynamic route calculations in the operations centre both during the route determination procedure and during the monitoring and updating procedure allows the amount of data exchanged between the operations centre 2 and the onboard navigation unit 4, and vice versa, to be significantly reduced and, in consequence, to limit the bandwidth of the channels of the communications network 6 necessary for data transmission. This allows the onboard navigation unit 4 to be made with not particularly high performance means of transmission and reception, processing and data storage, and so considerably reduces the manufacturing costs of the onboard navigation unit.

Finally, it is obvious that modifications and variants can be made to the system and method described and illustrated herein without leaving the scope of the protection of the present invention, as defined in the enclosed claims.

Alternatively, for example, the onboard navigation unit 4 could be configured to transmit the entire static route it has calculated to the operations centre and not a simplified version of it as previously described.

1. A vehicle navigation system, comprising an onboard navigation unit installed on board a vehicle that can be used by a user to set target destinations and an operations centre communicating with said onboard navigation unit and comprising means of monitoring traffic conditions and road conditions of at least one road network, in which said onboard navigation unit is configured to:
receive a target destination request from said user,
calculate, in response to said destination request, a first static road route based on information regarding the position of said vehicle and stored geographic data, and
provide said user with information regarding said first calculated static road route, characterized in that said onboard navigation unit is configured to:
transmit information associated with said target destination and said first static road route to said operations centre,
and that said operations centre is configured to:
calculate a dynamic road route based on said target destination, said first static road route and information regarding the traffic conditions and road conditions of said road network and/or said static road route,
compare said calculated dynamic road route with said first static road route, and
transmit information associated with a road route that is selected on the basis of said comparison to said onboard navigation unit.

2. The system according to claim 1, in which said operations centre is configured to:
calculate a journey time (t_{D}) for said dynamic road route and a journey time (t_{S}) for said first static road route,
compare said dynamic road route with said first static road route and said journey time (t_{D}) of said dynamic road route with said journey time (t_{S}) of said first static road route, and
transmit said dynamic road route and/or said journey time (t_{D}) of said dynamic road route or said journey time (t_{S}) of said first static road route to said onboard navigation unit (4) on the basis of said comparison.

3. The navigation system according to claim 2, in which said operations centre is configured to:
calculate said journey time (t_{D}) for said dynamic road route and said journey time (t_{S}) for said first static road route in cases where said dynamic road route is different from said first static road route, and
transmit said dynamic road route and said journey time (t_{D}) of said dynamic road route to said onboard navigation unit (4) in cases where said journey time (t_{D}) of said dynamic road route is less than said journey time (t_{S}) of said first static road route.

4. The navigation system according to claim 3, in which said operations centre is configured to:
transmit said journey time (t_{S}) of said first static road route to said onboard navigation unit (4) in cases where said journey time (t_{D}) of said dynamic road route is greater than said journey time (t_{S}) of said first static road route.

5. The navigation system according to claim 1, in which said operations centre is configured to:
calculate and transmit said journey time (t_{D}) of said dynamic road route to said onboard navigation unit (4) in cases where said dynamic road route is found to be equal to said first static road route.

6. The navigation system according to claim 1, in which said onboard navigation unit is also configured to:
calculate a second dynamic road route based on said dynamic road route received, and
provide said user information regarding said second dynamic road route and/or said journey time of said dynamic road route received, or information regarding said journey time of said first static road route.

7. The navigation system according to claim 1, in which said onboard navigation unit is also configured to:
acquire information regarding the position of said vehicle and information regarding vehicle road traffic around said vehicle, and
transmit said information regarding the position of said vehicle, said information regarding vehicle road traffic around said vehicle, said second dynamic road route and said target destination, to said operations centre.

8. The navigation system according to claim 7, in which said operations centre is configured to:
calculate said dynamic road route based on said information regarding the position of said vehicle, said information regarding vehicle road traffic around said vehicle, said second dynamic road route, information regarding the traffic conditions and the road conditions of said road network and/or said second dynamic road route, and said target destination.

9. The navigation system according to claim 1, in which said onboard navigation unit is also configured to:
calculate a simplified version of said first static road route, and
transmit said simplified version of said first static road route to said operations centre.

10. The navigation system according to claim 6, in which said onboard navigation unit is also configured to:
calculate a simplified version of said first static route or said second dynamic route, and
transmit said simplified version of said first static route or said second dynamic route to said operations centre.

11. The navigation system according to claim 1, in which said operations centre is configured to calculate said dynamic route based on said simplified version of said first static route or said second dynamic route.

12. The navigation system according to claim 1, in which said operations centre is configured to transmit said information regarding the traffic conditions and road conditions of said road network and/or said first static route or said dynamic route and/or said second dynamic route to said onboard navigation unit.

13. A vehicle navigation method, comprising:
receiving a target destination request from said user on an onboard navigation unit installed on board a vehicle,
calculating, in response to said request, a first static road route based on information regarding the position of said vehicle and geographic data stored in said onboard navigation unit,
providing said user with information regarding said first static road route,
transmitting said target destination and said first static road route to an operations centre,
calculating, at said operations centre, a dynamic road route based on said target destination, said first static road route and information regarding the traffic conditions and road conditions of said road network and/or said static road route,
comparing said calculated dynamic road route with said first static road route, and
transmitting information associated with a road route that is selected on the basis of said comparison to said onboard navigation unit.

14. The method according to claim 13, also comprising:
calculating, at said operations centre, a journey time (t_{D}) for said dynamic road route and a journey time (t_{S}) for said first static road route,
comparing said dynamic road route with said first static road route and said journey time (t_{D}) of said dynamic road route with said journey time (t_{S}) of said first static road route, and
transmitting said dynamic road route and/or said journey time (t_{D}) of said dynamic road route or said journey time (t_{S}) of said first static road route to said onboard navigation unit on the basis of said comparison.

15. The method according to claim 14, also comprising:
calculating said journey time (t_{D}) of said dynamic road route and said journey time (t_{S}) of said first static road route in cases where said dynamic road route is different from said first static road route, and
transmitting said dynamic road route and said journey time (t_{D}) of said dynamic road route to said onboard navigation unit in cases where said journey time (t_{D}) of said dynamic road route is less than said journey time (t_{S}) of said first static road route.

16. The method according to claim 15, also comprising:
transmitting said journey time (t_{S}) of said first static road route to said onboard navigation unit in cases where said journey time (t_{D}) of said dynamic road route is greater than said journey time (t_{S}) of said first static road route.

17. The method according to claim 13, also comprising:
calculating and transmitting said journey time (t_{D}) of said dynamic road route to said onboard navigation unit in cases where said dynamic road route is found to be equal to said first static road route.

18. The method according to claim 13, also comprising:
calculating a second dynamic road route based on said dynamic road route received, and
providing said user with information regarding said second dynamic road route and/or said journey time of said dynamic road route, or information regarding said journey time of said first static road route.

19. The method according to claim 13, also comprising:
acquiring information regarding the position of said vehicle and information regarding vehicle road traffic around said vehicle, and
transmitting said information regarding the position of said vehicle, said information regarding vehicle road traffic around said vehicle, said second dynamic road route and said target destination, to said operations centre.

20. The method according to claim 19, also comprising:
calculating said dynamic road route based on said information regarding the position of said vehicle, said information regarding vehicle road traffic around said vehicle, said second dynamic road route, information regarding the traffic conditions and the road conditions of said road network and/or said second dynamic road route, and said target destination.

21. The method according to claim 13, also comprising:
calculating a simplified version of said first static road route or said second dynamic road route, and
transmitting said simplified version of said first static road route or said second dynamic road route to said operations centre.

22. The method according to claims 13, also comprising:
calculating said dynamic route based on said simplified version of said first static road route or said second dynamic road route.

23. The method according to claim 13, also comprising:
transmitting said information regarding the traffic conditions and road conditions of said road network and/or said first static road route and/or said second dynamic road route to said onboard navigation unit.

24. A vehicle comprising an onboard navigation unit as defined in claim 1.
